(19) United States
(12) Patent Application Publication
(10) Pub. No.: US 2005/0201349 A1
(43) Pub. Date: Sep. 15, 2005

(54) Redundant wireless node network with coordinated receiver diversity

(75) Inventor: Ramakrishna S. Budampati, Plymouth, MN (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Honeywell International Inc.

(21) Appl. No.: 10/800,482

(22) Filed: Mar. 15, 2004

(51) Int. Cl. H04B 7/216

(52) U.S. Cl. 370/342

(57) ABSTRACT

A network of wireless nodes transmit electromagnetic signals, typically in the radio frequency (RF) mode, or at other frequencies. Multiple infrastructure nodes pick up the signals transmitted by each wireless node. The signals are combined to estimate the actual signal transmitted by the wireless node, such as a leaf node sensor. Many different diversity techniques may be used to combine the signals. In one embodiment, maximal ratio combining, equal gain combining, selection combining or switching combining is used to combine the signals.

### FIELD OF THE INVENTION

The present invention relates to wireless node networks, and in particular to a redundant wireless node network with coordinated receiver diversity.

### BACKGROUND OF THE INVENTION

Wireless nodes, such as sensors are networked via multiple base stations or access points that communicate with a central controller. The sensors operate at low power to conserve batteries, and to increase the time period in which batteries need to be replaced. This implies that the radio frequency (RF) signal generated by a sensor will have extremely low signal strength. The base stations are placed throughout the network of sensors, and wireless links between the base stations and sensors are highly susceptible to shadowing and fading effects, especially in indoor wireless environments. These effects are caused by RF propagation along multiple paths and by objects such as walls between the sensors and base stations. The effects adversely affect the range and reliability of the network. In traditional wireless sensor networks, each sensor reports to only one base station which in turn relays that signal to the control center. Fluctuations in the RF link between the sensor and the base station will affect the performance.

### SUMMARY OF THE INVENTION

A network of wireless nodes transmit electromagnetic signals, typically in the radio frequency (RF) mode, or at other frequencies. Multiple infrastructure nodes pick up the signals transmitted by each wireless node. The received signals are combined to estimate the actual signal transmitted by a wireless node. Many different diversity techniques may be used to combine the signals.

The use of wireless nodes, such as leaf nodes, provides great flexibility in leaf node placement, including places where wires cannot easily be run. Infrastructure nodes placement may be dictated by power availability in the case of line-powered wired infrastructure nodes. Line-powered or battery-powered wireless infrastructure nodes may also be utilized to provide greater flexibility in placement. The infrastructure nodes are placed by an installer to ensure redundant reception of leaf node transmissions, and thus diversity.

In one embodiment, the signals received by the infrastructure nodes are transmitted to a central device that combines the signals. In a further embodiment, the infrastructure nodes cooperate, such as by a master-slave type relationship to combine the signals. In other words, a master infrastructure node receives signals from one or more other infrastructure nodes that received the signal from the leaf node. The master infrastructure node then does the combining of these signals along with the signal it received directly if available.

In one embodiment, maximal ratio combining is used to combine the received signals. The received signal at each infrastructure node can be viewed as the transmitted signal times a wireless channel coefficient plus a noise factor. To obtain a leaf node's signal estimation, two or more received signals are multiplied again by the complex conjugates of their respective wireless channel coefficients and added resulting in a combined signal which has an increased signal-to-noise ratio (SNR) thus improving the estimation process.

In further embodiments, other diversity techniques include equal gain combining, selection combining, switched combining and other techniques. The diversity combining techniques may be used to increase SNR and thus improve the signal estimation process.

### BRIEF DESCRIPTION OF THE DRAWINGS

FIG. 1 is a block diagram of a network of wireless nodes utilizing diversity for leaf node's signal estimation according to an embodiment of the invention.

FIG. 2 is a block diagram of a wireless sensor/leaf node.

FIG. 3 is a block diagram of an embodiment of two infrastructure nodes receiving signal from a single wireless node.

FIG. 4 is a block diagram of a further embodiment of two infrastructure nodes receiving signal from a single wireless node.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or hardware, or a combination of software and hardware. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

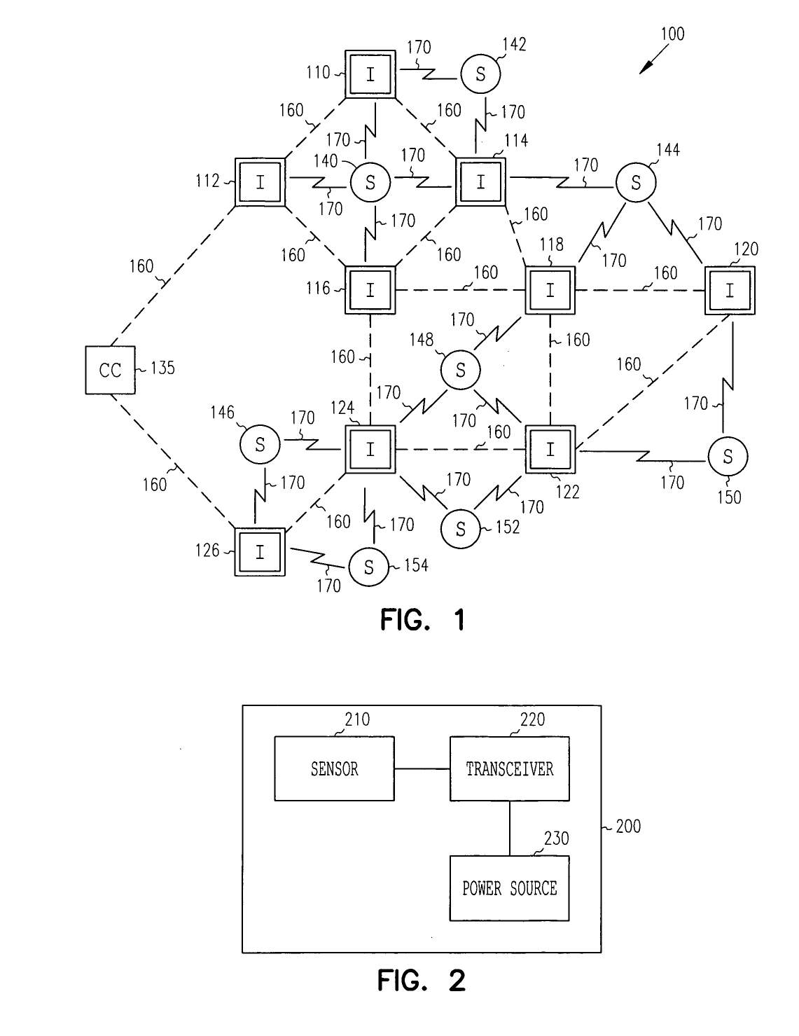

FIG. 1 shows a wireless network generally at 100. The wireless network in one embodiment comprises a number of intermediate nodes 110, 112, 114, 116, 118, 120, 122, 124 and 126, also referred to as infrastructure nodes. The infrastructure nodes are coupled to a central control 135. Associated with the infrastructure nodes are a plurality of wireless nodes 140, 142, 144, 146, 148, 150, 152, and 154. The wireless nodes may be leaf nodes in one embodiment that contain a sensor.

Infrastructure nodes may be coupled by a high power connection as indicated at 160. High power connection 160 may be in the form of a wireless connection, such as long range RF, or may also be a wired connection. The infrastructure nodes are also coupled to the central control 135 via connections 160. Connections 160 are shown in one particular arrangement, but are not intended to be limited to this type of arrangement. Any connection that provides suitable communications capabilities are within the meaning of connections 160.

Wireless nodes transmit signals as represented by lines 170 emanating toward selected infrastructure nodes. For instance, wireless node 140 is shown as transmitting a signal in multiple directions as represented by lines 170. Lines 170 show four infrastructure nodes, 110, 112, 114 and 116 as receiving a signal transmitted by wireless node 140. Each wireless node in FIG. 1 is represented as have its signals received by more than one infrastructure nodes. Some wireless node signals are only received by two infrastructure nodes, such as wireless node 152. Wireless node 152 has its signals only being received by infrastructure nodes 122 and 124. Further wireless nodes may have signals received by more than two infrastructure nodes, such as wireless nodes 140, 144, 148. While the network 100 may have some wireless nodes whose signals are not received by more than one infrastructure node, such wireless nodes' signals will not be estimated using diversity.

While a limited number of wireless nodes are shown in FIG. 1 for simplicity, it should be understood that each infrastructure node may receive signals from many more wireless nodes than represented. Larger numbers of infrastructure nodes may also be used in network 100.

The wireless nodes, shown in further detail in FIG. 2 at 200, in one embodiment comprise a sensor 210 coupled to a low power transceiver 220. Transceiver 220 may also have only transmit capability in further embodiments. The wireless node is powered by a battery 230, or may have another power source, such as solar power in one embodiment. The wireless node 200 transmits at a low power. Each wireless node is associated with at least one infrastructure node. In other words, it is located close enough to the associated infrastructure node such that it's signal transmitted at low power can be adequately received by the infrastructure node. In one embodiment, the wireless nodes are leaf nodes, but may be at any location within the network.

The signals transmitted by the sensors or wireless nodes are also received by other independent infrastructure nodes. The infrastructure nodes are spaced apart from each other, and more than one of them can receive the signals transmitted by sensors associated with a different independent infrastructure node. At least two infrastructure nodes receive signals from one wireless node. The combination of infrastructure nodes and associated wireless nodes provide the ability to monitor and or control a desired environment, such as an industrial process.

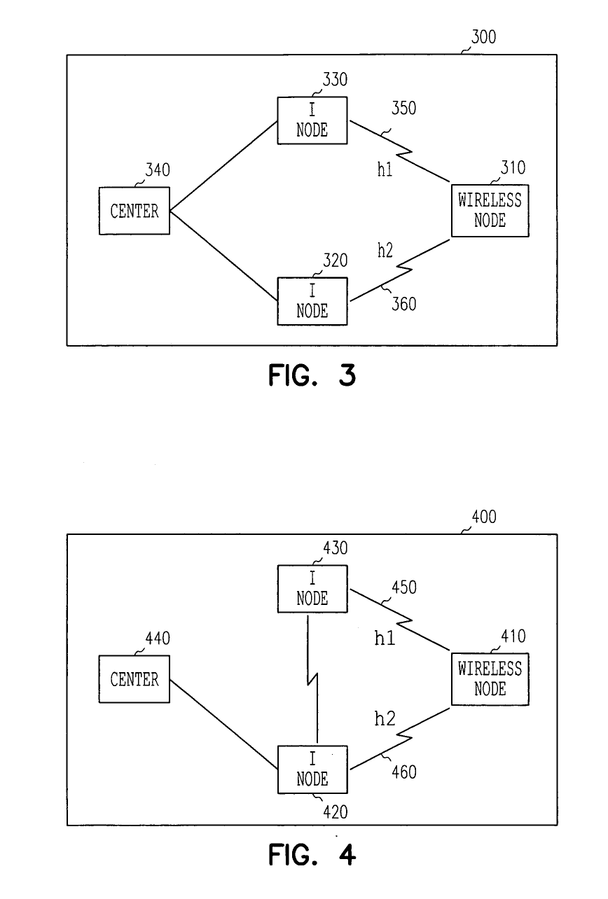

As seen in FIG. 3, a sensor/wireless node 310, transmits a signal that is received by a first infrastructure node 320 and a second infrastructure node 330. These infrastructure nodes further transmit the received signals to a control center 340. Each of the infrastructure nodes 320 and 330 receive signals from the sensor/wireless node over a wireless channel, each having a wireless channel coefficient h1 and h2 as indicated at 350 and 360. The wireless channel coefficient is a function of signal propagation along multiple paths and objects such as walls between the sensor/wireless node 310 and the infrastructure node. The wireless channel coefficient may be determined by sending a known signal and measuring the signal received at the infrastructure node.

The control center combines the received signals using a diversity technique. Diversity techniques have been in use by single devices with multiple antennas for receiving a signal. Such techniques include many different ways of combining the received signals to improve the estimation of the transmitted signal. In the present embodiments, the transmitted signals are received by independent infrastructure nodes that are spaced from each other, and associated with different sets of wireless nodes. In one embodiment, the infrastructure nodes send the received signal to the control center 340, which implements maximal ratio combining.

The received signal, r1 or r2, at each infrastructure node is a function of the channel coefficient (h1 or h2) times the transmitted signal (s) plus a noise factor, n1 or n2. Thus, the received signal at infrastructure node 330 is r1=h1×s+n1, and the received signal at infrastructure node 320 is r2=h2×s+n2. The received signals are then transmitted via high power wireless links, or hardwire links to the control center.

The control center uses the signals transmitted from the infrastructure nodes to compute the combined signal, rc. In one embodiment, maximal ratio combining is used:

rc=(h1″×r1+h2′×r2), where h1′(h2′) is the complex conjugate of h1(h2). The SNR of the combined signal is equal to the sum of the individual SNRs of r1 and r2, i.e., SNR_{rc}=SNRᵣ₁+SNRᵣ₂. The increased SNR improves the estimation process of the transmitted signal (s). In further embodiments, other diversity techniques, such as equal gain combining, selection combining, switched combining, and others may be used.

In one embodiment, the combining and estimation is provided by a module located in the control center 340. In an embodiment in FIG. 4, the combining and estimation is provided by one of the infrastructure nodes, and then is transmitted to the control center. In FIG. 4, a sensor/wireless node 410 transmits signals to infrastructure nodes 420 and 430. Infrastructure node 420 also receives a signal from infrastructure node 430 representative of the signal received at node 420. In one embodiment, the infrastructure nodes are externally powered, or otherwise have a high power source. They can thus transmit signals at a higher power, or may even be hardwired together. Infrastructure node 420 then provides the estimation to the central control 440.

1. A wireless network comprising:
multiple first wireless nodes that transmit signals;
multiple independent infrastructure nodes that receive the transmitted signals, wherein at least two infrastructure nodes receive a transmitted signal from a single first wireless node; and
a module that combines at least two of the signals received at the multiple independent infrastructure nodes to estimate the signal transmitted by the single first wireless node.

2. The wireless network of claim 1 and further comprising a central controller that receives signals from the independent infrastructure nodes and contains the module that combines the signals.

3. The wireless network of claim 2 wherein the infrastructure nodes are hardwired to the central controller.

4. The wireless network of claim 2 wherein the infrastructure node comprises a wireless transceiver for communicating with the central controller.

5. The wireless network of claim 1 wherein the first wireless nodes comprise sensors, and wherein the signals they transmit are representative of a sensed parameter.

6. The wireless network of claim 1 wherein the signals are combined using a diversity technique.

7. The wireless network of claim 6 wherein wireless channel coefficients that are associated with the RF links between the first wireless node and the infrastructure nodes are used for combining the signals.

8. The wireless network of claim 7 wherein the diversity technique comprises maximal ratio combining.

9. The wireless network of claim 1 wherein one of the infrastructure nodes receives signals from other infrastructure nodes and combines the signals received by the multiple infrastructure nodes.

10. An infrastructure node for a wireless network, the infrastructure node comprising:
a first receiver that receives a transmitted signal from a wireless node;
a second receiver that receives signals from other independent infrastructure nodes representative of the transmitted signal from the wireless node that were received by the other independent infrastructure nodes; and
a module that combines signal received from the wireless node and the signals from the other independent infrastructure nodes to estimate the signal transmitted by the wireless node.

11. The infrastructure node of claim 10 wherein the infrastructure node is hardwired to a central controller.

12. The infrastructure node of claim 10 and further comprising a wireless transceiver for communicating with a central controller.

13. The infrastructure node of claim 10 wherein the signals are combined using a diversity technique.

14. The infrastructure node of claim 13 wherein wireless channel coefficients that are associated with the RF links between the wireless node and the infrastructure nodes are used for combining the signals.

15. The infrastructure node of claim 13 wherein the diversity technique is selected from a group consisting of maximal ratio combining, equal gain combining, selection combining and switching combining.

16. A infrastructure node for a wireless network, the infrastructure node comprising:
means for receiving a transmitted signal from a wireless node;
means for receiving the signals from other independent infrastructure nodes representative of the transmitted signal from the wireless node; and
means for combining the signal received from the wireless node and the signals from the other independent infrastructure nodes to estimate the signal transmitted by the wireless node.

17. A wireless network comprising:
means for transmitting low power wireless signals;
multiple means for receiving the transmitted signals, wherein at least two of such means receive a transmitted signal from a single first wireless node; and
means for combining at least two of the signals received at the multiple means for receiving the transmitted signals for estimating the signal transmitted by the single first wireless node.

18. A method of processing signals at a infrastructure node for a wireless network, the infrastructure node performing the method comprising:
receiving a transmitted signal from a wireless node;
receiving the signals from other independent infrastructure nodes representative of the transmitted signal from the wireless node; and
combining the signal received from the wireless node and the signals from the other independent infrastructure nodes to estimate the signal transmitted by the wireless node.

19. A method of processing signals in a network having multiple independent infrastructure nodes and multiple nodes, the method comprising:
transmitting a signal from a first wireless node;
receiving the transmitted signal, wherein at least two infrastructure nodes receive the transmitted signal from the single first wireless node; and
combining the signals received by at least two of the multiple independent infrastructure nodes to estimate the signal transmitted by the single first wireless node.

20. The method of claim 19 wherein combining is performed by a central controller that receives signals from the independent infrastructure nodes.

21. The method of claim 19 wherein the signals are combined using a diversity technique.

22. The method of claim 21 wherein wireless channel coefficients that are associated with the RF links between the first wireless node and the infrastructure nodes are used for combining the signals.

23. The method of claim 22 wherein the diversity technique comprises maximal ratio combining.
